(19) United States
(12) Patent Application Publication
(10) Pub. No.: US 2026/0289614 A1
(43) Pub. Date: Sep. 24, 2026

(54) SYSTEMS AND METHODS FOR MATCHING SENIOR EXECUTIVES AND FINANCIAL SPONSORS

(71) Applicant: Kelly Sutton Harris, West Palm Beach, FL (US)

(72) Inventor: Kelly Sutton Harris, West Palm Beach, FL (US)

(21) Appl. No.: 19/688,121

(22) Filed: May 26, 2026

Related U.S. Application Data
(62) Division of application No. 18/970,702, filed on Dec. 5, 2024.
(60) Provisional application No. 63/542,575, filed on Oct. 5, 2023.

(51) Int. Cl. G06Q 30/0279; G06Q 10/42

(52) U.S. Cl. CPC G06Q 30/0279; G06Q 10/42

(57) ABSTRACT

A system for matching candidates to financial sponsors uses an artificial intelligence engine to interpret user inputs associated with a financial sponsor. The system classifies each user input as a document, a natural language query, or both, and identifies the type of any document received from a set of predefined types. Based on the document type, the system determines what information is missing and generates a ranked list of follow-up questions limited to the most impactful items. When classification confidence is below a set level, the system requests clarification before proceeding. The system then retrieves candidate profiles from a database, ranks them against a six-dimension rubric with override conditions, and produces a structured output including the ranked candidates, the retrieval plan used, and an audit trail documenting how the result was reached.

### CROSS-REFERENCE TO RELATED APPLICATIONS

The present application claims priority to U.S. Non-Provisional application Ser. No. 18/970,702 filed Dec. 5, 2024, titled “SYSTEM AND METHOD FOR MATCHING SENIOR EXECUTIVES AND FINANCIAL SPONSORS”, which is hereby incorporated by reference in its entirety.

### TECHNICAL FIELD

The embodiments disclosed herein generally relate to systems and methods for employer and employee personnel databases, and more specifically relates to systems and methods for matching candidates and financial sponsors.

### BACKGROUND

Personal and business development platforms exist which allow users to professionals and businesses to post jobs, create user profiles, and create advertisements. For professionals, profiles are created to connect with other professionals, businesses, organizations, and the like. Businesses may also use these platforms to promote their services, business developments, news, and to post job listings. However, platforms which are currently available allow nearly anyone to create such profiles, without the ability to verify user credentials and disseminate between user types.

### SUMMARY OF THE INVENTION

This summary is provided to introduce a variety of concepts in a simplified form that is further disclosed in the detailed description of the embodiments. This summary is not intended for determining the scope of the claimed subject matter.

The embodiments provided herein relate to a system for matching a candidate and a financial sponsor, including at least one user computing device in operable connection with a user network. An application server is in operable communication with the user network to host an application program for matching a candidate to a financial sponsor. The application program includes a user module enabling the generation of a candidate profile and a financial sponsor profile. A matching module matches a suitable candidate profile to a suitable financial sponsor profile, and a communication module enables the communication between a candidate and a financial sponsor.

The embodiments may be utilized to provide a self-service talent database and search platforms which matches qualified candidates (i.e., an executive) with job openings and/or financial sponsors. The system may utilize and AI engine to automatically match candidates based on their preferences, credentials, job history, locations, and other metrics to suitable financial sponsors, job openings, or other users.

Once a candidate is matched to the financial sponsors, they are able to communicate with one another regarding an opportunity, such as a financial sponsorship opportunity, job opening, or as part of a consultation.

The system is designed to verify users prior to their interactions with other users during the matching process. This provides an efficient means of connecting candidates with financial sponsors they may be interested in and allows businesses to eliminate the need for a corporate recruiter or outside recruiting service, thus greatly benefiting the business during the hiring process.

In one aspect, the system includes a verification module to verify the identity of the candidate. The the verification module is further enabled to verify one or more credentials of the candidate.

In one aspect, a recommendation module is in operable communication with an AI engine to receive one or more user inputs and to automatically match the one or more user inputs to the suitable financial sponsor.

In one aspect, a user module enables the generation of the candidate profile and the financial sponsor profile.

In one aspect, a user interface module is in operable communication with a display module to provide a plurality of user input fields wherein the user can input their personal information, preferences, location, work history, credentials, education history, highest title achieved, link their social media accounts, and otherwise input relevant information into the system to be used by the matching module, AI engine, and recommendation module.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a block diagram of an exemplary computer system infrastructure, according to some embodiments;

FIG. 2 illustrates a block diagram of the application program and modules, according to some embodiments.

FIG. 3 illustrates a flow diagram of an exemplary operational sequence of an input classification and document type classification module, according to some embodiments.

FIG. 4 illustrates a flow diagram of an exemplary operational sequence of a missing information and clarification question module, according to some embodiments.

FIG. 5 illustrates a flow diagram of an exemplary operational sequence of a confidence threshold gating and intent hypothesis module, according to some embodiments.

FIG. 6 illustrates a flow diagram of an exemplary operational sequence of a retrieval and ranking module, according to some embodiments.

FIG. 7 illustrates a flow diagram of an exemplary end-to-end operational flow of an intent clarification process, according to some embodiments.

### DETAILED DESCRIPTION OF THE INVENTION

The specific details of the single embodiment or variety of embodiments described herein are set forth in this application. Any specific details of the embodiments described herein are used for demonstration purposes only, and no unnecessary limitation(s) or inference(s) are to be understood or imputed therefrom.

Before describing in detail exemplary embodiments, it is noted that the embodiments reside primarily in combinations of components related to particular devices and systems. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In general, the embodiments provided herein relate to systems and methods to enable senior executives and financial sponsors to connect with one another using a platforms which verifies user credentials prior to them creating publicly available profiles on the platform. The system allows businesses to seek and communicate with executives who may be interested in joining the business as an executive member. To become a user, each user must be validated by the system in order to validate prior to them being able to communicate with the financial sponsors also using the system. Once the user's profile is made public, financial sponsors are able to communicate with the user directly via the platform's user interface. The system eliminates the need for an executive recruiter or similar “middleman”, commonly used to find qualified candidates for an executive role of a business.

As used herein, the term “user” may be used to define a candidate (i.e., an executive, senior executive, or qualified individual) who is seeking, or may be interested in seeking an opportunity offered by a business, organization, etc. The term “user” may also be used to describe financial sponsors (e.g., private equity firms, investors, groups of investors, family offices, venture capital firms, etc.) who are interested or may be interested in financially supporting other users or a business they are associated with. In some cases, the candidate may be described as the “first user” while the financial sponsor may be described as the “second user” or the “third-party user”.

The system enables both the executive (i.e., the primary user) and the financial sponsor (i.e., the secondary user) to search for suitable matches, communicate with each other, create hiring pipelines, post public media content (such as videos, photos, articles, etc.), and the like.

In some embodiments, the system includes a recommendation module for recommending matches between users (i.e., qualified executives) and financial sponsors. The recommendation module may receive user inputs including: user preferences, user qualifications, location, personal information, work history, and the like. This allows the recommendation module to recommend suitable candidates with financial sponsors which have similar interests, needs, and preferences as one another.

During use, candidates can submit an application and wait for the application to be approved by the business and/or financial sponsor. Once approved, they may then communicate with clients or other parties interested in their approved application. Financial sponsors may submit an application to provide financial support and also wait for their application to be approved. The financial sponsors may search for candidates based on their current needs in order to identify suitable candidates.

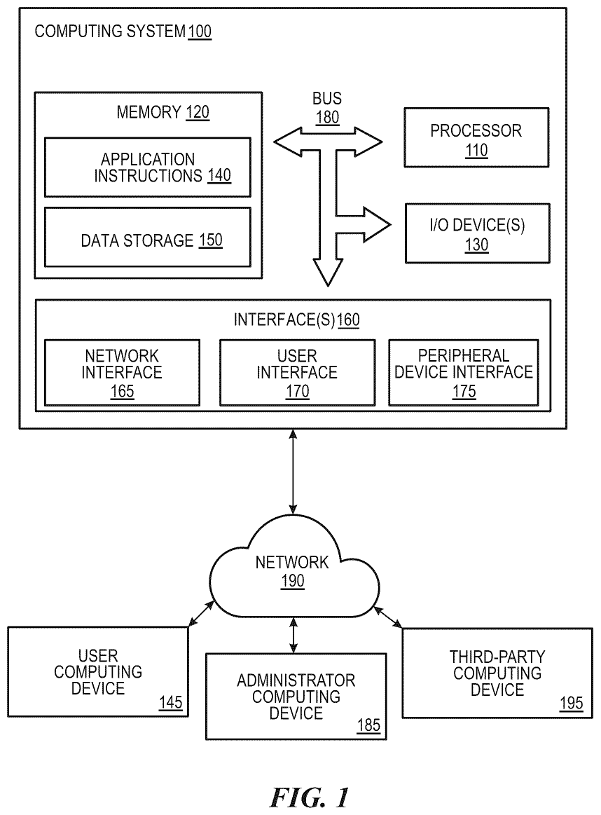

FIG. 1 illustrates an example of a computer system 100 that may be utilized to execute various procedures, including the processes described herein. The computer system 100 comprises a standalone computer or mobile computing device, a mainframe computer system, a workstation, a network computer, a desktop computer, a laptop, or the like. The computing device 100 can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive).

In some embodiments, the computer system 100 includes one or more processors 110 coupled to a memory 120 through a system bus 180 that couples various system components, such as an input/output (I/O) devices 130, to the processors 110. The bus 180 may be any of several types of bus structures including a memory bus or memory controller, a peripheral bus, and a local bus using any of a variety of bus architectures. For example, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, also known as Mezzanine bus.

In some embodiments, the computer system 100 includes one or more input/output (I/O) devices 130, such as video device(s) (e.g., a camera), audio device(s), and display(s) are in operable communication with the computer system 100. In some embodiments, similar I/O devices 130 may be separate from the computer system 100 and may interact with one or more nodes of the computer system 100 through a wired or wireless connection, such as over a network interface.

Processors 110 suitable for the execution of computer readable program instructions include both general and special purpose microprocessors and any one or more processors of any digital computing device. For example, each processor 110 may be a single processing unit or a number of processing units and may include single or multiple computing units or multiple processing cores. The processor(s) 110 can be implemented as one or more microprocessors, micro-computers, microcontrollers, digital signal processors, central processing units, state machines, logic circuitries, and/or any devices that manipulate signals based on operational instructions. For example, the processor(s) 110 may be one or more hardware processors and/or logic circuits of any suitable type specifically programmed or configured to execute the algorithms and processes described herein. The processor(s) 110 can be configured to fetch and execute computer readable program instructions stored in the computer-readable media, which can program the processor(s) 110 to perform the functions described herein.

In this disclosure, the term “processor” can refer to substantially any computing processing unit or device, including single-core processors, single-processors with software multithreading execution capability, multi-core processors, multi-core processors with software multithreading execution capability, multi-core processors with hardware multithread technology, parallel platforms, and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures, such as molecular and quantum-dot based transistors, switches, and gates, to optimize space usage or enhance performance of user equipment. A processor can also be implemented as a combination of computing processing units.

In some embodiments, the memory 120 includes computer-readable application instructions 150, configured to implement certain embodiments described herein, and a database 150, comprising various data accessible by the application instructions 140. In some embodiments, the application instructions 140 include software elements corresponding to one or more of the various embodiments described herein. For example, application instructions 140 may be implemented in various embodiments using any desired programming language, scripting language, or combination of programming and/or scripting languages (e.g., Android, C, C++, C #, JAVA, JAVASCRIPT, PERL, etc.).

In this disclosure, terms “store,” “storage,” “data store,” data storage,” “database,” and substantially any other information storage component relevant to operation and functionality of a component are utilized to refer to “memory components,” which are entities embodied in a “memory,” or components comprising a memory. Those skilled in the art would appreciate that the memory and/or memory components described herein can be volatile memory, nonvolatile memory, or both volatile and nonvolatile memory. Nonvolatile memory can include, for example, read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include, for example, RAM, which can act as external cache memory. The memory and/or memory components of the systems or computer-implemented methods can include the foregoing or other suitable types of memory.

Generally, a computing device will also include, or be operatively coupled to receive data from or transfer data to, or both, one or more mass data storage devices; however, a computing device need not have such devices. The computer readable storage medium (or media) can be a tangible device that can retain and store instructions for use by an instruction execution device. The computer readable storage medium can be, for example, an electronic storage device, a magnetic storage device, an optical storage device, an electromagnetic storage device, a semiconductor storage device, or any suitable combination of the foregoing. A non-exhaustive list of more specific examples of the computer readable storage medium can include: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. In this disclosure, a computer readable storage medium is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

In some embodiments, the steps and actions of the application instructions 140 described herein are embodied directly in hardware, in a software module executed by a processor, or in a combination of the two. A software module may reside in RAM, flash memory, ROM memory, EPROM memory, EEPROM memory, registers, a hard disk, a removable disk, a CD-ROM, or any other form of storage medium known in the art. An exemplary storage medium may be coupled to the processor 110 such that the processor 110 can read information from, and write information to, the storage medium. In the alternative, the storage medium may be integrated into the processor 110. Further, in some embodiments, the processor 110 and the storage medium may reside in an Application Specific Integrated Circuit (ASIC). In the alternative, the processor and the storage medium may reside as discrete components in a computing device. Additionally, in some embodiments, the events or actions of a method or algorithm may reside as one or any combination or set of codes and instructions on a machine-readable medium or computer-readable medium, which may be incorporated into a computer program product.

In some embodiments, the application instructions 140 for carrying out operations of the present disclosure can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The application instructions 140 can execute entirely on the user's computer, partly on the user's computer, as a stand-alone software package, partly on the user's computer and partly on a remote computer, or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform aspects of the present disclosure.

In some embodiments, the application instructions 140 can be downloaded to a computing/processing device from a computer readable storage medium, or to an external computer or external storage device via a network 190. A network adapter card or network interface in each computing/processing device receives computer readable program instructions from the network and forwards the computer readable application instructions 140 for storage in a computer readable storage medium within the respective computing/processing device.

In some embodiments, the computer system 100 includes one or more interfaces 160 that allow the computer system 100 to interact with other systems, devices, or computing environments. In some embodiments, the computer system 100 comprises a network interface 165 to communicate with a network 190. In some embodiments, the network interface 165 is configured to allow data to be exchanged between the computer system 100 and other devices attached to the network 190, such as other computer systems, or between nodes of the computer system 100. In various embodiments, the network interface 165 may support communication via wired or wireless general data networks, such as any suitable type of Ethernet network, for example, via telecommunications/telephony networks such as analog voice networks or digital fiber communications networks, via storage area networks such as Fiber Channel SANs, or via any other suitable type of network and/or protocol. Other interfaces include the user interface 170 and the peripheral device interface 175.

In some embodiments, the network 190 corresponds to a local area network (LAN), wide area network (WAN), the Internet, a direct peer-to-peer network (e.g., device to device Wi-Fi, Bluetooth, etc.), and/or an indirect peer-to-peer network (e.g., devices communicating through a server, router, or other network device). The network 190 can comprise copper transmission cables, optical transmission fibers, wireless transmission, routers, firewalls, switches, gateway computers and/or edge servers. The network 190 can represent a single network or multiple networks. In some embodiments, the network 190 used by the various devices of the computer system 100 is selected based on the proximity of the devices to one another or some other factor. For example, when a first user device and second user device are near each other (e.g., within a threshold distance, within direct communication range, etc.), the first user device may exchange data using a direct peer-to-peer network. But when the first user device and the second user device are not near each other, the first user device and the second user device may exchange data using a peer-to-peer network (e.g., the Internet). The Internet refers to the specific collection of networks and routers communicating using an Internet Protocol (“IP”) including higher level protocols, such as Transmission Control Protocol/Internet Protocol (“TCP/IP”) or the Uniform Datagram Packet/Internet Protocol (“UDP/IP”).

Any connection between the components of the system may be associated with a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. As used herein, the terms “disk” and “disc” include compact disc (CD), laser disc, optical disc, digital versatile disc (DVD), floppy disk, and Blu-ray disc; in which “disks” usually reproduce data magnetically, and “discs” usually reproduce data optically with lasers. Combinations of the above should also be included within the scope of computer-readable media. In some embodiments, the computer-readable media includes volatile and non-volatile memory and/or removable and non-removable media implemented in any type of technology for storage of information, such as computer-readable instructions, data structures, program modules, or other data. Such computer-readable media may include RAM, ROM, EEPROM, flash memory or other memory technology, optical storage, solid state storage, magnetic tape, magnetic disk storage, RAID storage systems, storage arrays, network attached storage, storage area networks, cloud storage, or any other medium that can be used to store the desired information and that can be accessed by a computing device. Depending on the configuration of the computing device, the computer-readable media may be a type of computer-readable storage media and/or a tangible non-transitory media to the extent that when mentioned, non-transitory computer-readable media exclude media such as energy, carrier signals, electromagnetic waves, and signals per se.

In some embodiments, the system is world-wide-web (www) based, and the network server is a web server delivering HTML, XML, etc., web pages to the computing devices. In other embodiments, a client-server architecture may be implemented, in which a network server executes enterprise and custom software, exchanging data with custom client applications running on the computing device.

In some embodiments, the system can also be implemented in cloud computing environments. In this context, “cloud computing” refers to a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

As used herein, the term “add-on” (or “plug-in”) refers to computing instructions configured to extend the functionality of a computer program, where the add-on is developed specifically for the computer program. The term “add-on data” refers to data included with, generated by, or organized by an add-on. Computer programs can include computing instructions, or an application programming interface (API) configured for communication between the computer program and an add-on. For example, a computer program can be configured to look in a specific directory for add-ons developed for the specific computer program. To add an add-on to a computer program, for example, a user can download the add-on from a website and install the add-on in an appropriate directory on the user's computer.

In some embodiments, the computer system 100 may include a user computing device 145 an administrator computing device 185 and a third-party computing device 195 each in communication via the network 190. The administrator computing device 185 is utilized by an administrative user to moderate content and to perform other administrative functions. The third-party computing device 195 may be utilized by third parties to receive communications from the user computing device, transmit communications to the user via the network, and otherwise interact with the various functionalities of the system.

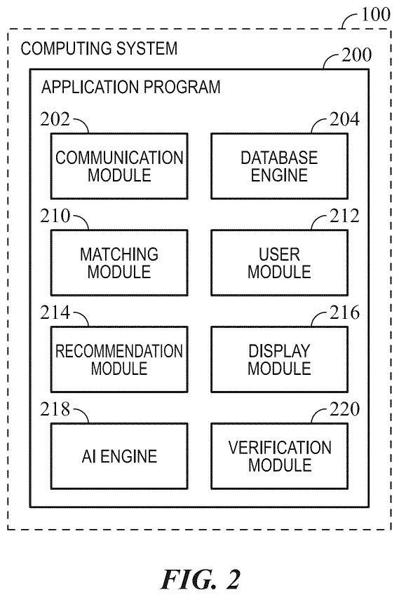

FIG. 2 illustrates an example computer architecture for the application program 200 operated via the computing system 100. The computing system 100 comprises several modules and engines configured to execute the functionalities of the application program 200, and a database engine 204 configured to facilitate how data is stored and managed in one or more databases. In particular, FIG. 2 is a block diagram showing the modules and engines needed to perform specific tasks within the application program 200.

Referring to FIG. 2, the computing system 100 operating the application program 200 comprises one or more modules having the necessary routines and data structures for performing specific tasks, and one or more engines configured to determine how the platform manages and manipulates data. In some embodiments, the application program 200 comprises one or more of a communication module 202, a database engine 204, a matching module 210, a user module 212, a recommendation module 214, a display module 216, an AI engine 218, and a verification module 220.

In some embodiments, the communication module 202 is configured for receiving, processing, and transmitting a user command and/or one or more data streams. In such embodiments, the communication module 202 performs communication functions between various devices, including the user computing device 145, the administrator computing device 185, and a third-party computing device 195. In some embodiments, the communication module 202 is configured to allow one or more users of the system, including a third-party, to communicate with one another. In some embodiments, the communications module 202 is configured to maintain one or more communication sessions with one or more servers, the administrative computing device 185, and/or one or more third-party computing device(s) 195. The communication module 202 is operable to transmit communications between verified users seeking an opportunity.

In some embodiments, a database engine 204 is configured to facilitate the storage, management, and retrieval of data to and from one or more storage mediums, such as the one or more internal databases described herein. In some embodiments, the database engine 204 is coupled to an external storage system. In some embodiments, the database engine 204 is configured to apply changes to one or more databases. In some embodiments, the database engine 204 comprises a search engine component for searching through thousands of data sources stored in different locations.

In some embodiments, the matching module 210 is operable to receive user inputs and match users based on commonalities between the inputs such as a common industry, qualifications, preferences, etc.

In some embodiments, the user module 212 facilitates the creation of a user account for the application system. The user module 212 may allow the user to create a user profile which includes user information, user preferences, and user-associated information. The user module may also be used to assign a user type to each user. The user module may enable the user to establish preferences which may include the region wherein the student user's access is not permitted, a time period during which access to the non-permitted application is not permitted, user credentials and identity, etc. The user account 212 may be used to create a candidate account, financial sponsor account, business account, etc.

In some embodiments, the recommendation module 214 may operate the AI engine 218 in order to recommend users to one another based on preferences, qualifications, locations, etc.

In some embodiments, the display module 216 is configured to display one or more graphic user interfaces, including, e.g., one or more user interfaces, one or more consumer interfaces, one or more video presenter interfaces, etc. In some embodiments, the display module 216 is configured to temporarily generate and display various pieces of information in response to one or more commands or operations. The various pieces of information or data generated and displayed may be transiently generated and displayed, and the displayed content in the display module 216 may be refreshed and replaced with different content upon the receipt of different commands or operations in some embodiments. In such embodiments, the various pieces of information generated and displayed in a display module 216 may not be persistently stored.

In some embodiments, the verification module 220 verifies the user's identity to determine if the user's work history, financial information, etc.

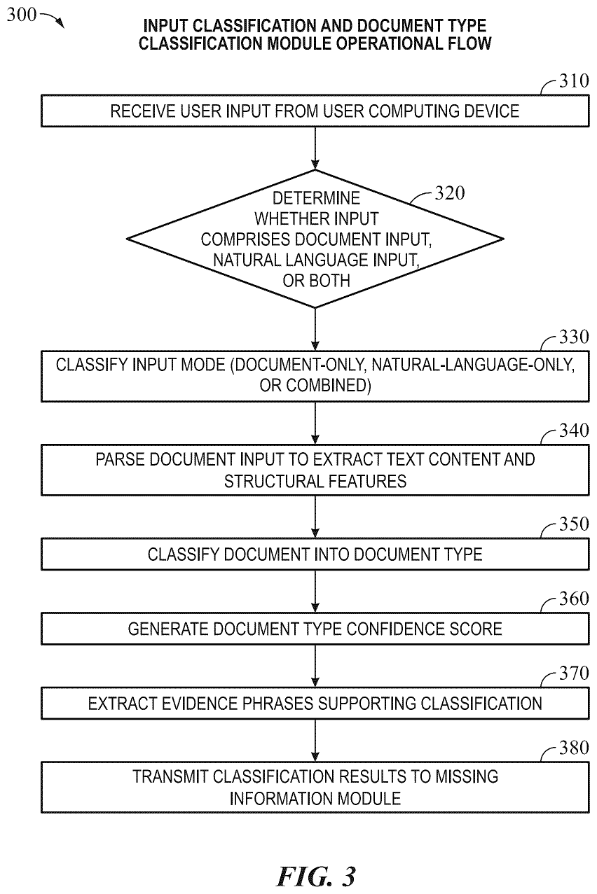

In some embodiments, the AI engine 218 is further configured to execute an intent clarification process for interpreting user inputs received from the user computing device 145, classifying document inputs received from the user computing device 145, determining missing information associated with the user inputs, generating ranked sets of clarification questions, retrieving candidate profiles from a candidate database, ranking the retrieved candidate profiles against a multi-dimensional rubric, and generating structured outputs documenting the intent clarification process. The intent clarification process is described in further detail with reference to FIGS. 3 through 7. In some embodiments, the intent clarification process is executed by the AI engine 218 in cooperation with the recommendation module 214, the matching module 210, the communication module 202, the user module 212, the display module 216, the verification module 220, and the database engine 204.

In some embodiments, the intent clarification process is implemented as a plurality of operational modules executed by the processor 110 within the application program 200, including an input classification and document type classification module 300, a missing information and clarification question module 400, a confidence threshold gating and intent hypothesis module 500, a retrieval and ranking module 600, and a structured output generation module 700. In some embodiments, the modules 300, 400, 500, 600, and 700 are implemented as sub-components of the AI engine 218 and operate in cooperation with the other modules of the application program 200 to perform the intent clarification process. In some embodiments, the communication module 202 receives user inputs from the user computing device 145 via the network 190 and transmits the user inputs to the module 300 for processing. In some embodiments, the display module 216 generates user interfaces that display clarification questions generated by the module 400 and structured outputs generated by the module 700 to the user of the user computing device 145. In some embodiments, the verification module 220 cooperates with the module 600 to confirm the identity of candidates associated with candidate profiles retrieved from the candidate database prior to inclusion of the candidate profiles in the structured output. In some embodiments, the matching module 210 operates on ranked candidate profiles generated by the module 600 to match the candidate profiles to the financial sponsor profile.

In some embodiments, the computing system 100 maintains a candidate database within the data storage 150, wherein the candidate database is managed by the database engine 204 and stores a plurality of candidate profiles accessible to the AI engine 218 during execution of the intent clarification process. In some embodiments, the candidate database is implemented as a logical data store within the data storage 150. In other embodiments, the candidate database is implemented as a separate data store accessible to the computing system 100 via the network 190. In some embodiments, the database engine 204 further manages storage of a predefined mapping of a plurality of document types to required information fields, a predefined mapping of missing information fields to clarification question templates, and predefined safety thresholds and override conditions used by the module 600 during ranking operations. In some embodiments, the database engine 204 provides the predefined mappings, override conditions, and other data to the modules 300, 400, 500, 600, and 700 in response to queries received during execution of the intent clarification process.

FIG. 3 is a flow diagram illustrating an exemplary operational sequence of the input classification and document type classification module 300 in accordance with some embodiments. The sequence shown may be implemented as computer-executable instructions within the application program 200 operating on the computing system 100 of FIG. 2, with specific operations performed by the AI engine 218 and the other modules depicted therein.

At step 310, a user input is received from the user computing device 145. This operation may be performed by the module 300 in coordination with the communication module 202. In some embodiments, a user of the user computing device 145 submits the user input through a user interface generated by the display module 216 and transmitted to the user computing device 145 via the network 190. The communication module 202 may receive the submitted user input via the network 190 and forward the user input to the module 300 for processing. In some embodiments, the user input comprises at least one of a document input and a natural language input, where the document input may include a deal teaser, an investment theme document, a job description, a resume, a company description, or similar documentation associated with a financial sponsor, and the natural language input may include textual queries, search criteria, or specifications submitted by the user of the user computing device 145. In some embodiments, the module 300 stores the received user input temporarily within the data storage 150 via the database engine 204 pending completion of classification operations.

At step 320, a determination is made regarding whether the user input comprises the document input, the natural language input, or both. This operation is performed by the module 300, which analyzes the received user input to identify its composition. In some embodiments, the module 300 examines file attachments, payload structure, and content type indicators transmitted with the user input to identify whether a document file is present. In some embodiments, the module 300 evaluates unstructured text fields within the user input to identify whether natural language content is present. The module 300 may determine that the user input comprises the document input when an attached file is identified, may determine that the user input comprises the natural language input when unstructured text is identified, and may determine that the user input comprises both when an attached file and unstructured text are identified in combination.

At step 330, the user input is classified into an input mode selected from a plurality of input modes. This operation is performed by the module 300 based on the determination from step 320. In some embodiments, the plurality of input modes comprises a document-only mode, a natural-language-only mode, and a document-plus-natural-language mode. The module 300 may classify the user input into the document-only mode when the determination indicates that the user input comprises the document input without accompanying natural language input. The module 300 may classify the user input into the natural-language-only mode when the determination indicates that the user input comprises the natural language input without accompanying document input. The module 300 may classify the user input into the document-plus-natural-language mode when the determination indicates that the user input comprises both the document input and the natural language input. In some embodiments, the classified input mode is associated with priority rules that govern how subsequent operations weight the document input relative to the natural language input, where the natural language input may be treated as paramount when both are present, and the document input may be treated as supporting context.

At step 340, the document input is parsed to extract text content and structural features. This operation is performed by the module 300 based on the user input comprising the document input. In some embodiments, the module 300 applies text extraction algorithms to the document input to generate a text corpus comprising machine-readable text from the document input. The module 300 may apply structural analysis algorithms to the document input to identify structural features comprising document sections, headings, formatting patterns, tables, lists, and similar structural elements. In some embodiments, the module 300 applies optical character recognition (OCR) algorithms to document inputs comprising image-based or scanned content to generate machine-readable text. In some embodiments, the extracted text content and structural features are stored temporarily within the data storage 150 for use in subsequent classification operations.

At step 350, the document input is classified into a document type selected from a plurality of predefined document types. This operation is performed by the module 300 based on the extracted text content and structural features from step 340. In some embodiments, the plurality of predefined document types comprises a deal teaser type, an investment theme type, a job description type, a resume type, a company description type, and an other type. The module 300 may apply classification algorithms to the extracted text content and structural features to determine which of the plurality of predefined document types most closely matches the document input. In some embodiments, the classification algorithms comprise keyword matching algorithms that compare extracted text content against predefined keyword sets associated with each document type, structural pattern matching algorithms that compare identified structural features against predefined structural signatures associated with each document type, or machine learning classification models trained on a corpus of labeled documents representing each document type. For example, the module 300 may classify the document input as the job description type based on identifying keywords such as “responsibilities,” “qualifications,” and “reporting structure,” and may classify the document input as the resume type based on identifying structural features comprising a work history section and an education history section.

At step 360, a document type confidence score associated with the classified document type is generated. This operation is performed by the module 300 based on the classification from step 350. In some embodiments, the document type confidence score is a numerical value representing the degree of match between the document input and the classified document type. The module 300 may calculate the document type confidence score based on the number of matching keywords identified in the extracted text content, the number of matching structural features identified, the output probability generated by a machine learning classification model, or combinations thereof. In some embodiments, the document type confidence score is expressed as a value between 0.0 and 1.0, where a value of 1.0 represents a high degree of confidence that the document input matches the classified document type, and a value of 0.0 represents a low degree of confidence. The document type confidence score is subsequently used by the confidence threshold gating and intent hypothesis module 500 to determine whether the intent clarification process should proceed or whether additional clarification from the user of the user computing device 145 is required.

At step 370, one or more evidence phrases supporting the classification of the document input are extracted. This operation is performed by the module 300 based on the classification from step 350. In some embodiments, the one or more evidence phrases comprise textual excerpts from the document input that contributed to classification of the document input into the classified document type. The module 300 may identify the one or more evidence phrases by tracking which portions of the extracted text content triggered keyword matches or structural pattern matches during step 350. For example, when the document input is classified as the deal teaser type, the module 300 may extract an evidence phrase comprising a sentence describing a target company's revenue and earnings before interest, taxes, depreciation, and amortization (EBITDA)figures that triggered the deal teaser classification. In some embodiments, the one or more evidence phrases are subsequently included in an audit trail generated by the structured output generation module 700 to document the basis for classification decisions made during the intent clarification process.

At step 380, the classified input mode, the classified document type, the document type confidence score, and the one or more evidence phrases are transmitted to the missing information and clarification question module 400. This operation is performed by the module 300 in coordination with the database engine 204. In some embodiments, the module 300 generates a classification result object comprising the classified input mode, the classified document type, the document type confidence score, and the one or more evidence phrases, and transmits the classification result object to the module 400 for use in subsequent missing information and clarification question generation operations. In some embodiments, the module 300 stores the classification result object within the data storage 150 via the database engine 204 to enable retrieval by other modules during subsequent operations.

In some embodiments, the operations of steps 310 through 380 occur automatically upon receipt of the user input at the user computing device 145, while in some embodiments the operations may be initiated on-demand by the user of the user computing device 145 through a control interface generated by the display module 216. In some embodiments, the operations of steps 310 through 380 are performed on user inputs received from multiple user computing devices 145 concurrently, enabling the module 300 to classify and process a plurality of user inputs in parallel. The automated execution of the operations of steps 310 through 380 reduces processing time that would otherwise be required to manually determine input composition, classify document inputs into appropriate document types, and identify evidence supporting classification decisions, and enables subsequent operations of the intent clarification process to be tailored to the specific input mode and document type of each user input received.

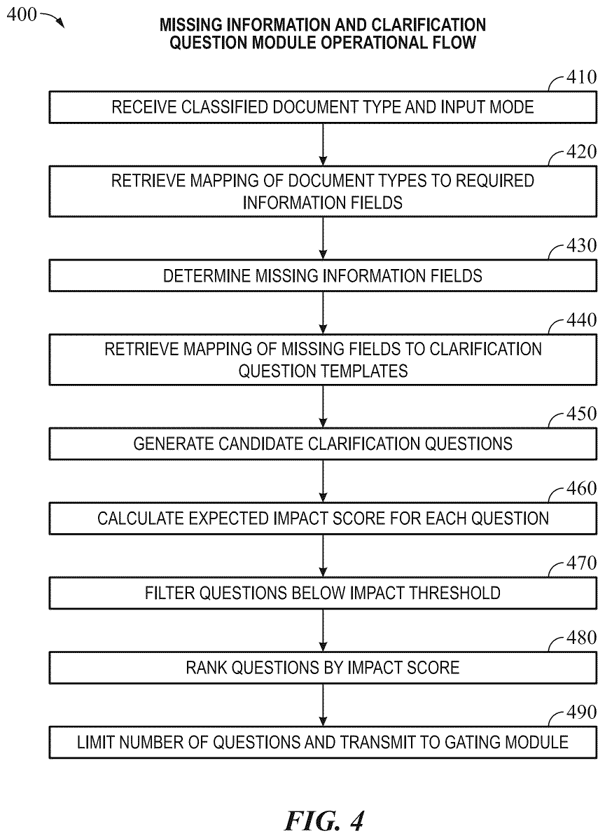

FIG. 4 is a flow diagram illustrating an exemplary operational sequence of the missing information and clarification question module 400 in accordance with some embodiments. The sequence shown may be implemented as computer-executable instructions within the application program 200 operating on the computing system 100 of FIG. 2, with specific operations performed by the AI engine 218 and the other modules depicted therein.

At step 410, the classified document type and input mode are received from the module 300. This operation is performed by the module 400, which receives the classification result object generated by the module 300 at step 380 of FIG. 3. In some embodiments, the module 400 parses the received classification result object to extract the classified document type, the classified input mode, the document type confidence score, and the one or more evidence phrases for use in subsequent operations. In some embodiments, the module 400 receives classification result objects for multiple user inputs concurrently, enabling parallel processing of missing information determinations for a plurality of user inputs.

At step 420, a predefined mapping of a plurality of document types to required information fields is retrieved. This operation is performed by the module 400 in coordination with the database engine 204. In some embodiments, the predefined mapping is stored within the data storage 150 and associates each of the plurality of predefined document types with a set of required information fields needed to perform ranking operations for user inputs of that document type. For example, the predefined mapping may associate the deal teaser type with required information fields comprising a purpose of engagement field, a target scale range field, and a geography constraint field. The predefined mapping may associate the job description type with required information fields comprising a prior role requirement field, a private-equity-backed experience requirement field, a target scale range field, and a sector strictness level field. The predefined mapping may associate the resume type with required information fields comprising a near-clone candidate preference field, a broader analog candidate preference field, and a role-ready candidate preference field. The predefined mapping may associate the investment theme type with required information fields comprising a sector-specific operating experience field, a title specificity field, and a sector strictness level field. The predefined mapping may associate the company description type with required information fields comprising a same-company experience preference field and a broader sector experience preference field. In some embodiments, the module 400 retrieves the set of required information fields associated with the classified document type by querying the database engine 204 using the classified document type as a query parameter.

At step 430, a set of missing information fields is determined based on the classified document type. This operation is performed by the module 400 based on the set of required information fields retrieved at step 420. In some embodiments, the module 400 compares the set of required information fields against information content present in the user input received at step 310 of FIG. 3 to identify which of the required information fields are not satisfied by the user input. The module 400 may parse the extracted text content and structural features of the document input, along with any accompanying natural language input, to identify information that satisfies individual required information fields. A required information field may be identified as missing when the parsing operation does not identify information within the user input that satisfies the required information field. In some embodiments, the set of missing information fields comprises one or more required information fields identified as missing during the comparison.

At step 440, a predefined mapping of missing information fields to clarification question templates is retrieved. This operation is performed by the module 400 in coordination with the database engine 204. In some embodiments, the predefined mapping is stored within the data storage 150 and associates each of a plurality of information fields with one or more clarification question templates configured to elicit information satisfying that information field. For example, the predefined mapping may associate the purpose of engagement field with a clarification question template inquiring whether the user seeks executives for a deal evaluation purpose, a sector perspective purpose, a board role placement purpose, a chief executive placement purpose, or an operating role placement purpose. The predefined mapping may associate the target scale range field with a clarification question template inquiring about revenue thresholds, employee counts, or profit-and-loss ranges acceptable to the user. The predefined mapping may associate the sector-specific operating experience field with a clarification question template inquiring whether the user requires deep operating experience in the exact sector of interest or whether senior operators having broad sector experience are acceptable. The predefined mapping may associate the same-company experience preference field with a clarification question template inquiring whether the user seeks executives from a specific company identified in the company description or whether executives having experience in a broader sector associated with the company are acceptable. In some embodiments, the module 400 retrieves the one or more clarification question templates associated with each of the missing information fields identified at step 430 by querying the database engine 204.

At step 450, candidate clarification questions are generated based on the missing information fields and the corresponding clarification question templates. This operation is performed by the module 400 based on the clarification question templates retrieved at step 440. In some embodiments, the module 400 populates each clarification question template with context-specific parameters derived from the classified document type, the one or more evidence phrases, and the input mode to generate a candidate clarification question tailored to the user input. For example, when the classified document type is the job description type and the target scale range field is identified as missing, the module 400 may populate a clarification question template to generate a candidate clarification question such as “What revenue range best characterizes the target operating scale for this role?” In some embodiments, the module 400 generates a plurality of candidate clarification questions, with each candidate clarification question addressing one of the missing information fields.

At step 460, an expected impact score is calculated for each of the candidate clarification questions. This operation is performed by the module 400 based on the generated candidate clarification questions. In some embodiments, the expected impact score represents the degree to which the answer to a candidate clarification question is expected to affect the ranking of a plurality of candidate profiles generated during subsequent ranking operations. The module 400 may calculate the expected impact score based on factors comprising the number of candidate profiles affected by the missing information field associated with the candidate clarification question, the magnitude of ranking changes that would result from resolving the missing information field, the correlation between the missing information field and dimensions of a multi-dimensional rubric used during ranking operations, or combinations thereof. In some embodiments, the expected impact score is expressed as a numerical value between 0.0 and 1.0, where a value of 1.0 represents a high expected impact on the ranking of the plurality of candidate profiles, and a value of 0.0 represents a low expected impact.

At step 470, candidate clarification questions having expected impact scores below a predefined impact threshold are filtered from consideration. This operation is performed by the module 400 based on the expected impact scores calculated at step 460. In some embodiments, the predefined impact threshold is stored within the data storage 150 and represents a minimum expected impact score required for a candidate clarification question to be presented to the user of the user computing device 145. The module 400 may compare the expected impact score of each candidate clarification question against the predefined impact threshold and may exclude candidate clarification questions having expected impact scores below the predefined impact threshold from subsequent operations. In some embodiments, the filtering operation enables the module 400 to present only clarification questions that materially affect downstream ranking results, reducing user burden associated with answering low-value clarification questions.

At step 480, remaining candidate clarification questions are ranked by expected impact score in descending order. This operation is performed by the module 400 based on the candidate clarification questions remaining after the filtering operation at step 470. In some embodiments, the module 400 sorts the remaining candidate clarification questions such that candidate clarification questions having higher expected impact scores are ordered before candidate clarification questions having lower expected impact scores. In some embodiments, where two or more candidate clarification questions have equal expected impact scores, the module 400 may apply secondary ordering criteria comprising the document type relevance of the associated missing information field, the user preference history retrieved from the data storage 150, or default ordering rules.

At step 490, the ranked candidate clarification questions are limited to a predefined maximum number and transmitted to the confidence threshold gating and intent hypothesis module 500. This operation is performed by the module 400 based on the ranked candidate clarification questions from step 480. In some embodiments, the predefined maximum number is stored within the data storage 150 and represents an upper limit on the number of clarification questions presented to the user of the user computing device 145 during a single iteration of the intent clarification process. For example, the predefined maximum number may be set to five, such that the module 400 selects the top five ranked candidate clarification questions and excludes remaining candidate clarification questions from the ranked set of clarification questions transmitted to the module 500. In some embodiments, the module 400 generates a ranked question result object comprising the ranked set of clarification questions and the associated expected impact scores, and transmits the ranked question result object to the module 500.

In some embodiments, the operations of steps 410 through 490 occur automatically upon receipt of the classification result object from the module 300, while in some embodiments the operations may be initiated on-demand through a control interface generated by the display module 216. In some embodiments, the predefined mapping of document types to required information fields, the predefined mapping of missing information fields to clarification question templates, the predefined impact threshold, and the predefined maximum number are configurable by an administrator user of the administrator computing device 185 to accommodate organizational preferences and usage patterns. The automated execution of the operations of steps 410 through 490 reduces processing time that would otherwise be required to manually identify missing information, formulate clarification questions, and prioritize questions based on expected downstream impact, and enables the intent clarification process to elicit only high-value clarification questions rather than exhaustive question sets that impose unnecessary burden on the user of the user computing device 145.

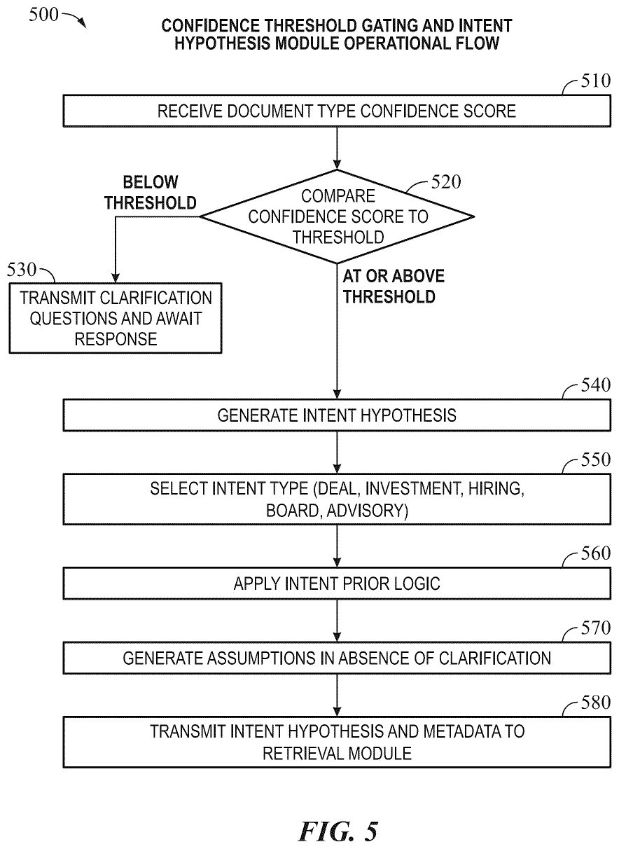

FIG. 5 is a flow diagram illustrating an exemplary operational sequence of the confidence threshold gating and intent hypothesis module 500 in accordance with some embodiments. The sequence shown may be implemented as computer-executable instructions within the application program 200 operating on the computing system 100 of FIG. 2, with specific operations performed by the AI engine 218 and the other modules depicted therein.

At step 510, the document type confidence score is received from the module 300. This operation is performed by the module 500, which receives the document type confidence score generated by the module 300 at step 360 of FIG. 3. In some embodiments, the module 500 further receives the ranked set of clarification questions generated by the module 400 at step 490 of FIG. 4. In some embodiments, the module 500 receives the classified document type, the classified input mode, and the one or more evidence phrases to support subsequent gating and intent hypothesis operations.

At step 520, the document type confidence score is compared to a predefined confidence threshold. This operation is performed by the module 500 based on the document type confidence score received at step 510. In some embodiments, the predefined confidence threshold is stored within the data storage 150 and represents a minimum document type confidence score at which the intent clarification process may proceed without requiring additional clarification from the user of the user computing device 145. The module 500 may retrieve the predefined confidence threshold from the data storage 150 via the database engine 204 and compare the document type confidence score against the predefined confidence threshold using numerical comparison operations. In some embodiments, the predefined confidence threshold is configurable by an administrator user of the administrator computing device 185 to balance precision of classification against user burden associated with answering clarification questions.

At step 530, based on the document type confidence score being below the predefined confidence threshold, the ranked set of clarification questions is transmitted to the user computing device 145 and a response is awaited. This operation is performed by the module 500 in coordination with the communication module 202 and the display module 216. In some embodiments, the module 500 generates a clarification request object comprising the ranked set of clarification questions and transmits the clarification request object to the display module 216, which generates a user interface configured to present the clarification questions to the user of the user computing device 145. The communication module 202 may transmit the generated user interface to the user computing device 145 via the network 190. In some embodiments, the module 500 awaits receipt of a clarification response from the user computing device 145, where the clarification response comprises user-supplied answers to one or more of the clarification questions in the ranked set of clarification questions. Upon receipt of the clarification response, the module 500 may augment the user input with the user-supplied answers and may return to step 510 to re-evaluate the document type confidence score based on the augmented user input.

At step 540, based on the document type confidence score being at or above the predefined confidence threshold, an intent hypothesis associated with the user input is generated. This operation is performed by the module 500 based on the comparison result from step 520. In some embodiments, the intent hypothesis represents a determination by the module 500 regarding the purpose for which the user of the user computing device 145 submitted the user input. The module 500 may generate the intent hypothesis based on the classified document type, the classified input mode, the one or more evidence phrases, and natural language content of the user input.

At step 550, the intent hypothesis is selected from a plurality of intent types. This operation is performed by the module 500 based on the intent hypothesis generated at step 540. In some embodiments, the plurality of intent types comprises a deal assessment intent, an investment theme intent, a hiring intent, a board intent, and an advisory intent. The module 500 may select the deal assessment intent when the classified document type is the deal teaser type and the user input indicates evaluation of a specific transaction. The module 500 may select the investment theme intent when the classified document type is the investment theme type and the user input indicates exploration of a sector or opportunity area. The module 500 may select the hiring intent when the classified document type is the job description type or when the user input specifies a concrete role title. The module 500 may select the board intent or the advisory intent when the user input indicates placement of a candidate in a board role or an advisory role, respectively.

At step 560, intent prior logic is applied to the selection of the intent hypothesis. This operation is performed by the module 500 based on the plurality of intent types and the content of the user input. In some embodiments, the intent prior logic comprises rule-based selection criteria that govern how the module 500 defaults to particular intent types in the absence of contradicting signals in the user input. The module 500 may select the hiring intent as the intent hypothesis based on the user input specifying a role title. The module 500 may select the deal assessment intent as a default intent hypothesis based on the user input not specifying the role title and not providing other signals that contradict the deal assessment intent. In some embodiments, the intent prior logic enables the module 500 to generate consistent intent hypotheses for user inputs that provide limited signals regarding user purpose, reducing ambiguity in subsequent retrieval and ranking operations.

At step 570, one or more assumptions applied in the absence of clarification responses are generated and associated with the intent hypothesis. This operation is performed by the module 500 based on the intent hypothesis selected at step 550 and the intent prior logic applied at step 560. In some embodiments, the one or more assumptions comprise explicit statements of default parameter values applied by the module 500 when the user input does not provide sufficient specification of those parameters. For example, when the user input does not specify a geography constraint, the module 500 may apply an assumption that no geography constraint is imposed. When the user input does not specify a recency window, the module 500 may apply an assumption that candidate experience within the past ten years is preferred. In some embodiments, the one or more assumptions are subsequently included in an audit trail generated by the structured output generation module 700 to document the basis for determinations made during the intent clarification process.

At step 580, the intent hypothesis, the one or more assumptions, and gating decision metadata are transmitted to the retrieval and ranking module 600. This operation is performed by the module 500 in coordination with the database engine 204. In some embodiments, the module 500 generates an intent hypothesis result object comprising the intent hypothesis, the one or more assumptions, the classified document type, the classified input mode, the document type confidence score, and the gating decision metadata indicating whether the intent clarification process proceeded directly at step 540 or proceeded after receipt of a clarification response at step 530. The module 500 may transmit the intent hypothesis result object to the module 600 for use in subsequent retrieval and ranking operations and may store the intent hypothesis result object within the data storage 150 via the database engine 204.

In some embodiments, the operations of steps 510 through 580 occur automatically upon receipt of the document type confidence score from the module 300 and the ranked set of clarification questions from the module 400, while in some embodiments the operations may be initiated on-demand through a control interface generated by the display module 216. In some embodiments, the predefined confidence threshold and the intent prior logic are configurable by an administrator user of the administrator computing device 185 to accommodate organizational preferences. The automated execution of the operations of steps 510 through 580 reduces processing time that would otherwise be required to manually evaluate classification confidence, solicit clarification, infer user purpose, and document assumptions, and enables the intent clarification process to proceed efficiently when classification confidence is sufficient while soliciting clarification only when classification confidence is insufficient.

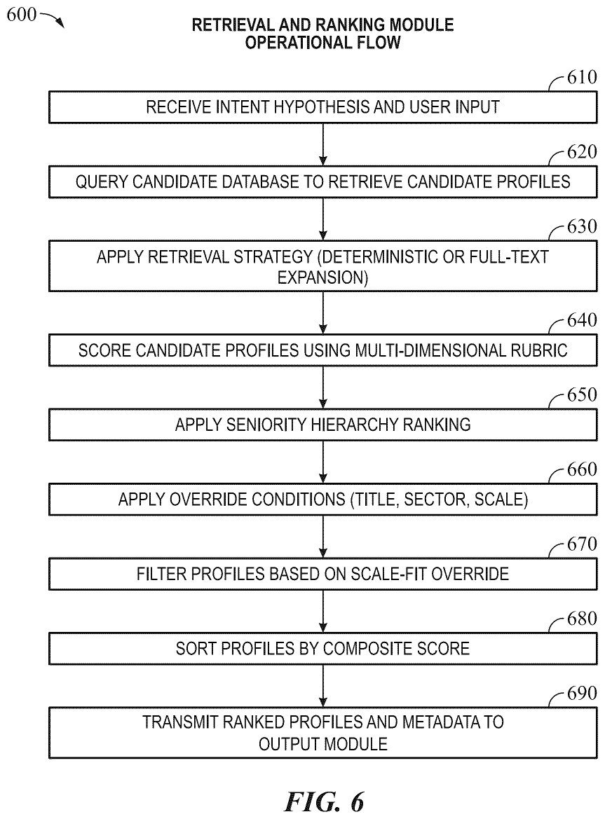

FIG. 6 is a flow diagram illustrating an exemplary operational sequence of the retrieval and ranking module 600 in accordance with some embodiments. The sequence shown may be implemented as computer-executable instructions within the application program 200 operating on the computing system 100 of FIG. 2, with specific operations performed by the AI engine 218 and the other modules depicted therein.

At step 610, the intent hypothesis and the user input are received from the module 500. This operation is performed by the module 600, which receives the intent hypothesis result object generated by the module 500 at step 580 of FIG. 5. In some embodiments, the module 600 parses the received intent hypothesis result object to extract the intent hypothesis, the one or more assumptions, the classified document type, the classified input mode, the document type confidence score, and the gating decision metadata for use in subsequent retrieval and ranking operations.

At step 620, the candidate database is queried to retrieve a subset of candidate profiles based on the user input. This operation is performed by the module 600 in coordination with the database engine 204. In some embodiments, the module 600 generates a retrieval query based on the intent hypothesis, the classified document type, and content of the user input, and transmits the retrieval query to the database engine 204. The database engine 204 may execute the retrieval query against the candidate database maintained within the data storage 150 and may return a subset of candidate profiles matching the retrieval query. In some embodiments, the subset of candidate profiles comprises candidate profiles associated with candidates having at least one attribute matching a parameter specified in the retrieval query, where the attributes may comprise candidate work history, candidate credentials, candidate location, candidate preferences, candidate operational experience, or similar candidate information.

At step 630, a retrieval strategy is applied to generation of the retrieval query. This operation is performed by the module 600 based on the content of the user input and the intent hypothesis. In some embodiments, the retrieval strategy is selected from a deterministic retrieval strategy and a full-text expansion retrieval strategy. The module 600 may select the deterministic retrieval strategy based on the user input specifying a structured constraint, where the structured constraint may comprise a specific sector, a specific title level, a specific scale range, a specific geography, or similar structured parameter. The module 600 may select the full-text expansion retrieval strategy based on the user input lacking the structured constraint. In some embodiments, application of the deterministic retrieval strategy results in generation of a retrieval query that filters candidate profiles based on exact matches or defined value ranges associated with the structured constraint. In some embodiments, application of the full-text expansion retrieval strategy results in generation of a retrieval query that performs semantic expansion of natural language content of the user input to identify candidate profiles having attributes semantically related to the natural language content.

At step 640, each candidate profile of the subset of candidate profiles is scored against a multi-dimensional rubric. This operation is performed by the module 600 based on the subset of candidate profiles retrieved at step 620. In some embodiments, the multi-dimensional rubric comprises a seniority dimension, a recency dimension, a tenure length dimension, an ownership context dimension, an operational scale dimension, and a relevant engagement count dimension. The seniority dimension may represent the seniority level of roles previously held by the candidate associated with each candidate profile. The recency dimension may represent the temporal proximity of the candidate's experience to a present time, where experience within approximately ten years may be preferred. The tenure length dimension may represent the duration of the candidate's experience in relevant roles, where five or more years may indicate strong tenure and ten or more years may indicate exceptional tenure. The ownership context dimension may represent the ownership structure of businesses in which the candidate previously held roles, where private equity ownership may be preferred, public ownership may be treated as strong, and private non-private-equity ownership may be treated as acceptable. The operational scale dimension may represent the size of operations managed by the candidate, measured in revenue, employee count, or profit-and-loss responsibility. The relevant engagement count dimension may represent the number of relevant prior engagements the candidate has held. The module 600 may calculate a dimensional score for each candidate profile on each dimension and may combine the dimensional scores into a composite score using weighted summation or similar aggregation operations.

At step 650, a seniority hierarchy ranking is applied within the seniority dimension. This operation is performed by the module 600 based on the dimensional scores calculated at step 640. In some embodiments, the seniority hierarchy comprises a ranked ordering of roles in which a chief executive officer (CEO) role is ranked above a board role, the board role is ranked above a chief operating officer (COO) role, and the COO role is ranked above a chief financial officer (CFO) role. The module 600 may adjust the seniority dimensional score for each candidate profile based on the seniority hierarchy, assigning higher seniority dimensional scores to candidate profiles associated with candidates having held roles higher in the seniority hierarchy. In some embodiments, additional seniority levels may be accommodated by extension of the seniority hierarchy to include other executive roles.

At step 660, one or more override conditions specified in the user input are applied. This operation is performed by the module 600 based on the user input received at step 610. In some embodiments, the one or more override conditions comprise a title-specificity override, a sector-expertise override, and a scale-fit override. The module 600 may apply the title-specificity override based on the user input specifying a title level, such that a title match is weighted above the seniority dimension during ranking operations. The module 600 may apply the sector-expertise override based on the user input specifying a sector strictness level above a sector strictness threshold, such that a sector match is weighted above the ownership context dimension during ranking operations. In some embodiments, the module 600 adjusts the composite scores of candidate profiles based on the applied override conditions to reflect the prioritization specified by the user input.

At step 670, the subset of candidate profiles is filtered based on the scale-fit override. This operation is performed by the module 600 based on the one or more override conditions applied at step 660. In some embodiments, the module 600 applies the scale-fit override based on the user input specifying a target scale range, where the target scale range may be expressed in revenue thresholds, employee count ranges, profit-and-loss ranges, or similar scale parameters. The module 600 may compare the operational scale associated with each candidate profile against the target scale range and may exclude from the subset of candidate profiles any candidate profile associated with an operational scale outside the target scale range. In some embodiments, the module 600 further receives verification results from the verification module 220 confirming the identity and credentials of the candidates associated with the remaining candidate profiles, and may exclude from the subset any candidate profile for which verification fails.

At step 680, the subset of candidate profiles is sorted by composite score to generate a ranked subset of candidate profiles. This operation is performed by the module 600 based on the composite scores calculated at step 640 and adjusted at steps 650, 660, and 670. In some embodiments, the module 600 sorts the subset of candidate profiles in descending order of composite score, such that candidate profiles having higher composite scores are ordered before candidate profiles having lower composite scores. The sorted subset may comprise the ranked subset of candidate profiles for inclusion in subsequent structured output operations.

At step 690, the ranked subset of candidate profiles and retrieval strategy metadata are transmitted to the structured output generation module 700. This operation is performed by the module 600 in coordination with the database engine 204. In some embodiments, the module 600 generates a ranking result object comprising the ranked subset of candidate profiles, the retrieval strategy applied at step 630, the multi-dimensional rubric scores calculated at step 640, the seniority hierarchy adjustments applied at step 650, the one or more override conditions applied at step 660, and the filtering applied at step 670. The module 600 may transmit the ranking result object to the module 700 for use in subsequent structured output generation operations and may store the ranking result object within the data storage 150 via the database engine 204. In some embodiments, the module 600 further transmits the ranked subset of candidate profiles to the matching module 210 to match the ranked subset of candidate profiles to a financial sponsor profile.

In some embodiments, the operations of steps 610 through 690 occur automatically upon receipt of the intent hypothesis result object from the module 500, while in some embodiments the operations may be initiated on-demand through a control interface generated by the display module 216. In some embodiments, the multi-dimensional rubric, the seniority hierarchy, the sector strictness threshold, and the target scale range are configurable by an administrator user of the administrator computing device 185 to accommodate organizational preferences. The automated execution of the operations of steps 610 through 690 reduces processing time that would otherwise be required to manually query candidate profiles, apply multi-dimensional ranking criteria, and filter candidates based on scale compatibility, and enables the intent clarification process to produce ranked subsets of candidate profiles that reflect both structured constraints specified in the user input and domain-specific ranking heuristics.

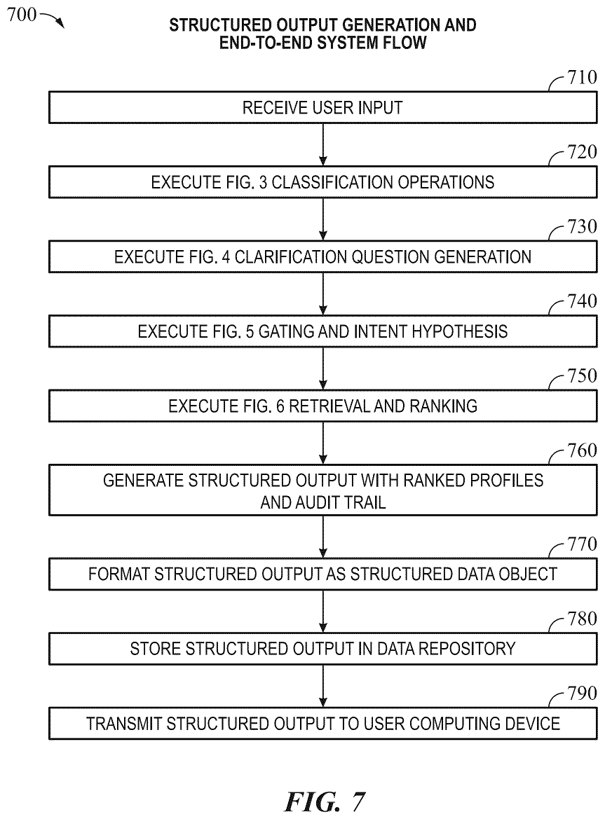

FIG. 7 is a flow diagram illustrating an exemplary end-to-end operational flow of the intent clarification process in accordance with some embodiments. The sequence shown may be implemented as computer-executable instructions within the application program 200 operating on the computing system 100 of FIG. 2, demonstrating the integrated operation of the modules 300, 400, 500, 600, and 700 to process user inputs from initial receipt through structured output transmission.

At step 710, a user input is received from the user computing device 145 via the network 190. This operation is performed by the communication module 202 in coordination with the module 300. In some embodiments, the user of the user computing device 145 submits the user input through a user interface generated by the display module 216 and transmitted to the user computing device 145 via the network 190. The communication module 202 may receive the submitted user input via the network 190 and forward the user input to the module 300 for processing. In some embodiments, the user input comprises at least one of a document input and a natural language input associated with a financial sponsor.

At step 720, classification operations are executed to generate a classified input mode, a classified document type, a document type confidence score, and one or more evidence phrases. This operation is performed by the module 300 according to the operational sequence of FIG. 3. In some embodiments, the module 300 classifies the user input into the classified input mode selected from a plurality of input modes, classifies the document input into the classified document type selected from a plurality of predefined document types, generates the document type confidence score associated with the classified document type, and extracts the one or more evidence phrases supporting the classification.

At step 730, clarification question generation operations are executed to generate a ranked set of clarification questions. This operation is performed by the module 400 according to the operational sequence of FIG. 4. In some embodiments, the module 400 determines a set of missing information fields based on the classified document type, generates candidate clarification questions based on the set of missing information fields, calculates expected impact scores for the candidate clarification questions, and ranks the candidate clarification questions by expected impact score to generate the ranked set of clarification questions, limited to a predefined maximum number.

At step 740, confidence threshold gating and intent hypothesis operations are executed to determine whether to proceed with retrieval or request clarification. This operation is performed by the module 500 according to the operational sequence of FIG. 5. In some embodiments, the module 500 compares the document type confidence score against a predefined confidence threshold, transmits the ranked set of clarification questions to the user computing device 145 when the document type confidence score is below the predefined confidence threshold, generates an intent hypothesis associated with the user input when the document type confidence score is at or above the predefined confidence threshold, and generates one or more assumptions associated with the intent hypothesis.

At step 750, retrieval and ranking operations are executed to generate a ranked subset of candidate profiles. This operation is performed by the module 600 according to the operational sequence of FIG. 6. In some embodiments, the module 600 queries the candidate database to retrieve a subset of candidate profiles based on the user input and the intent hypothesis, applies a retrieval strategy selected from a deterministic retrieval strategy and a full-text expansion retrieval strategy, scores the subset of candidate profiles against a multi-dimensional rubric comprising a seniority dimension, a recency dimension, a tenure length dimension, an ownership context dimension, an operational scale dimension, and a relevant engagement count dimension, applies one or more override conditions to the scoring, and sorts the subset of candidate profiles by composite score to generate the ranked subset of candidate profiles.

At step 760, a structured output comprising the ranked subset of candidate profiles, a retrieval plan, and an audit trail is generated. This operation is performed by the module 700 based on the ranking result object received from the module 600. In some embodiments, the module 700 compiles the ranked subset of candidate profiles, generates the retrieval plan identifying the retrieval strategy applied by the module 600 at step 630 of FIG. 6, and generates the audit trail identifying the classified input mode, the classified document type, the set of missing information fields, the intent hypothesis, the one or more evidence phrases, the one or more assumptions, and a ranking rationale describing the multi-dimensional rubric scores and override conditions applied during ranking operations.

At step 770, the structured output is formatted as a structured data object comprising a plurality of named fields. This operation is performed by the module 700 based on the compilation from step 760. In some embodiments, the structured data object comprises an intent field identifying the intent hypothesis and a confidence associated with the intent hypothesis, a classification field identifying the classified input mode and the classified document type, a missing information field identifying the set of missing information fields, a clarifying questions field identifying the ranked set of clarification questions, a retrieval plan field identifying the retrieval plan, and an audit trail field identifying the audit trail. In some embodiments, the structured data object is formatted as a JavaScript Object Notation (JSON) document. In other embodiments, the structured data object is formatted as an Extensible Markup Language (XML) document, a YAML Ain't Markup Language (YAML) document, or any other structured serialization format suitable for machine parsing by downstream systems.

At step 780, the structured output is stored in the data storage 150 via the database engine 204. This operation is performed by the module 700 in coordination with the database engine 204. In some embodiments, the module 700 transmits the formatted structured output to the database engine 204, which stores the structured output within the data storage 150. The stored structured output may be indexed by user identifiers, timestamps, classified document types, and intent hypotheses to enable efficient retrieval by subsequent queries. In some embodiments, the database engine 204 synchronizes the stored structured output with third-party computing devices 195 via the network 190, enabling external systems to access the structured output for downstream processing.

At step 790, the structured output is transmitted to the user computing device 145 via the communication module 202. This operation is performed by the module 700 in coordination with the communication module 202 and the display module 216. In some embodiments, the display module 216 generates a user interface configured to present the structured output to the user of the user computing device 145, where the user interface may display the ranked subset of candidate profiles, the retrieval plan, and the audit trail in a human-readable format. The communication module 202 may transmit the generated user interface to the user computing device 145 via the network 190. In some embodiments, the structured output is further transmitted to the administrator computing device 185 to enable administrative review of the intent clarification process and to the third-party computing device 195 to enable downstream processing by external systems.

In some embodiments, the operations of steps 710 through 790 represent a complete end-to-end workflow for processing user inputs through the intent clarification process. The integrated operation of the modules 300, 400, 500, 600, and 700 enables the computing system 100 to receive user inputs, classify inputs by mode and document type, determine missing information and generate ranked clarification questions, apply confidence threshold gating to determine whether clarification is required, generate intent hypotheses and associated assumptions, retrieve and rank candidate profiles from the candidate database using domain-specific ranking heuristics and override conditions, and generate structured outputs with associated retrieval plans and audit trails. By integrating input classification, missing information determination, clarification question generation, intent hypothesis generation, retrieval, ranking, and structured output generation into a unified intent clarification process, the computing system 100 may reduce processing time, eliminate manual information gathering steps, produce auditable determinations regarding user intent and candidate ranking, and enable consistent processing of user inputs associated with financial sponsors across the plurality of predefined document types and input modes.

Various implementations of the present disclosure involve the technical field of computer-based information retrieval and candidate ranking systems for financial sponsor matching operations, including executing algorithms to classify user inputs received from the user computing device 145 by input mode and document type, integrating structured signals extracted from document inputs into clarification question generation operations, applying rule-based logic to filter and rank clarification questions based on expected impact on downstream ranking results, generating intent hypotheses based on rule-based selection criteria and intent prior logic, retrieving candidate profiles from the candidate database using deterministic and full-text expansion retrieval strategies, applying multi-dimensional ranking rubrics with domain-specific hierarchies and override conditions to score candidate profiles, and generating auditable structured outputs documenting classification decisions, missing information determinations, intent hypotheses, assumptions, retrieval strategies, and ranking rationales. These operations are inherently computer-based and cannot be performed in the human mind or using pen and paper due to the volume, speed, and complexity of the data being processed. For example, the computing system 100 executes the operations of receiving user inputs from multiple user computing devices 145 concurrently, parsing document inputs to extract text content and structural features, querying the candidate database maintained within the data storage 150 to retrieve subsets of candidate profiles from a plurality of candidate profiles, evaluating multiple classification criteria simultaneously, calculating expected impact scores across candidate clarification questions, scoring candidate profiles across a plurality of ranking dimensions with applied override conditions, and generating structured outputs in real-time based on integrated data from multiple modules 300, 400, 500, 600, and 700.

The present disclosure amounts to more than merely implementing a generic computer as a tool to gather, analyze, and output data because the claimed operations improve the field of financial sponsor matching by enabling automated, rule-driven intent clarification that actively determines user purpose, identifies missing information, generates ranked clarification questions, and produces auditable structured outputs rather than relying on unconstrained free-form generation. In particular, the speed at which the operations of the present disclosure occur to effectuate the disclosed method, system, or product would involve real-time processing of user inputs, instantaneous classification of document inputs across a plurality of predefined document types, continuous evaluation of classification confidence against predefined confidence thresholds, and immediate generation of ranked clarification questions when classification confidence is insufficient. The operations of the present disclosure are impossible to accomplish on pen and paper, cannot be accomplished as a method of organizing human activity, and amount to more than merely gathering, analyzing, and outputting data.

The present disclosure further provides a specific technical improvement over conventional matching systems by implementing a precision-filtering architecture that returns a ranked subset of candidate profiles satisfying defined relevance criteria rather than returning an unfiltered result set requiring manual review by the user of the user computing device 145. Conventional matching systems typically return large numbers of candidate profiles based on loose keyword matches or broad demographic criteria, imposing on the user the burden of manually evaluating each returned candidate profile against the user's actual requirements. The computing system 100 addresses this limitation by executing the confidence threshold gating operations of the module 500 to solicit clarification when classification confidence is insufficient, executing the impact-score filtering operations of the module 400 to present only clarification questions that materially affect downstream ranking results, and executing the multi-dimensional rubric scoring and override condition filtering operations of the module 600 to exclude candidate profiles that do not satisfy defined relevance criteria. This precision-filtering architecture reduces the computational cost of downstream review operations, reduces the user burden associated with evaluating irrelevant candidate profiles, and produces auditable candidate rankings that reflect defined relevance criteria rather than unfiltered result sets.

Various implementations of the present disclosure include executing computer-implemented classification algorithms, missing information determination routines, impact score calculation algorithms, confidence threshold comparison operations, intent hypothesis generation routines, retrieval strategy selection algorithms, multi-dimensional ranking algorithms, and structured output formatting operations on computing hardware to produce auditable candidate rankings in response to user inputs associated with financial sponsors. The computing system 100 implements these algorithms when it performs tasks such as comparing document type confidence scores to predefined confidence thresholds, parsing document inputs to extract text content and structural features, applying predefined mappings of document types to required information fields, calculating expected impact scores for candidate clarification questions, selecting retrieval strategies based on structured constraints present in user inputs, scoring candidate profiles against the multi-dimensional rubric comprising the seniority dimension, the recency dimension, the tenure length dimension, the ownership context dimension, the operational scale dimension, and the relevant engagement count dimension, applying the seniority hierarchy ranking the CEO role above the board role, the board role above the COO role, and the COO role above the CFO role, applying the title-specificity override, the sector-expertise override, and the scale-fit override to ranking operations, and generating structured data objects comprising the intent field, the classification field, the missing information field, the clarifying questions field, the retrieval plan field, and the audit trail field. In particular, the speed at which the computing system 100 processes user inputs received concurrently from multiple user computing devices 145, applies predefined mappings and ranking rubrics across a plurality of candidate profiles retrieved from the candidate database, and generates auditable structured outputs would involve continuous, high-frequency data processing across networked systems. The present disclosure would be impossible to accomplish on pen and paper or in the human mind due to the volume of user inputs being processed, the number of simultaneous classification and ranking operations being performed, and the speed required to generate auditable candidate rankings that reflect both structured constraints specified in user inputs and domain-specific ranking heuristics.

In some embodiments, the module 300 processes user inputs by executing classification operations that determine input composition, classify user inputs into input modes, parse document inputs to extract text content and structural features, classify document inputs into document types from the plurality of predefined document types comprising the deal teaser type, the investment theme type, the job description type, the resume type, the company description type, and the other type, generate document type confidence scores, and extract evidence phrases supporting classification decisions. The module 400 executes queries against the predefined mapping of document types to required information fields and the predefined mapping of missing information fields to clarification question templates stored within the data storage 150, applies impact score calculation algorithms to candidate clarification questions, and filters candidate clarification questions based on the predefined impact threshold. The module 500 executes confidence threshold comparison operations between document type confidence scores and the predefined confidence threshold, generates intent hypotheses selected from the plurality of intent types comprising the deal assessment intent, the investment theme intent, the hiring intent, the board intent, and the advisory intent, applies intent prior logic to intent hypothesis selection, and generates assumptions associated with intent hypotheses. The module 600 executes retrieval queries against the candidate database, applies retrieval strategies selected from the deterministic retrieval strategy and the full-text expansion retrieval strategy, calculates multi-dimensional rubric scores, applies the seniority hierarchy and override conditions, and filters candidate profiles based on the scale-fit override. The module 700 executes structured output formatting operations that produce structured data objects comprising the plurality of named fields. The foregoing operations are executed as sequences of database queries, algorithmic comparisons, conditional logic evaluations, and network communications across distributed systems, and cannot practically be performed in the human mind or on paper. These concrete processing steps of input classification, rule-based clarification question generation, confidence threshold gating, intent hypothesis generation, candidate retrieval and ranking, and auditable structured output generation provide a specific improvement to computer-based information retrieval and candidate ranking systems by enabling rule-driven intent clarification with auditable outputs, rather than a mere abstract idea of organizing human activity or unconstrained free-form generation.

In this disclosure, the various embodiments are described with reference to the flowchart illustrations and/or block diagrams of methods, apparatus (systems), and computer program products.

Those skilled in the art would understand that each block of the flowchart illustrations and/or block diagrams, and combinations of blocks in the flowchart illustrations and/or block diagrams, can be implemented by computer readable program instructions. The computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions or acts specified in the flowchart and/or block diagram block or blocks. The computer readable program instructions can be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks. The computer readable program instructions can be loaded onto a computer, other programmable data processing apparatus, or other device to cause a series of operational acts to be performed on the computer, other programmable apparatus, or other device to produce a computer implemented process, such that the instructions that execute on the computer, other programmable apparatus, or other device implement the functions or acts specified in the flowchart and/or block diagram block or blocks.

In this disclosure, the block diagrams in the Figures illustrate the architecture, functionality, and operation of possible implementations of systems, methods, and computer program products according to the various embodiments. Each block in the flowchart or block diagrams can represent a module, segment, or portion of instructions, which comprises one or more executable instructions for implementing the specified logical function(s). In some embodiments, the functions noted in the blocks can occur out of the order noted in the Figures. For example, two blocks shown in succession can, in fact, be executed concurrently or substantially concurrently, or the blocks can sometimes be executed in the reverse order, depending upon the functionality involved. In some embodiments, each block of the block diagrams and/or flowchart illustration, and combinations of blocks in the block diagrams and/or flowchart illustration, can be implemented by a special purpose hardware-based system that performs the specified functions or acts or carry out combinations of special purpose hardware and computer instructions.

In this disclosure, the subject matter has been described in the general context of computer-executable instructions of a computer program product running on a computer or computers, and those skilled in the art would recognize that this disclosure can be implemented in combination with other program modules. Generally, program modules include routines, programs, components, data structures, etc. that perform particular tasks and/or implement particular abstract data types. Those skilled in the art would appreciate that the computer-implemented methods disclosed herein can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated embodiments can be practiced in distributed computing environments where tasks are performed by remote processing devices that are linked through a communications network. Some embodiments of this disclosure can be practiced on a stand-alone computer. In a distributed computing environment, program modules can be located in both local and remote memory storage devices.

In this disclosure, the terms “component,” “system,” “platform,” “interface,” and the like, can refer to and/or include a computer-related entity or an entity related to an operational machine with one or more specific functionalities. The disclosed entities can be hardware, a combination of hardware and software, software, or software in execution. For example, a component can be a process running on a processor, a processor, an object, an executable, a thread of execution, a program, and/or a computer. By way of illustration, both an application running on a server and the server can be a component. One or more components can reside within a process and/or thread of execution and a component can be localized on one computer and/or distributed between two or more computers. In another example, respective components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As another example, a component can be an apparatus that provides specific functionality through electronic components without mechanical parts, wherein the electronic components can include a processor or other means to execute software or firmware that confers at least in part the functionality of the electronic components. In some embodiments, a component can emulate an electronic component via a virtual machine, e.g., within a cloud computing system.

The phrase “application” as is used herein means software other than the operating system, such as Word processors, database managers, Internet browsers and the like. Each application generally has its own user interface, which allows a user to interact with a particular program. The user interface for most operating systems and applications is a graphical user interface (GUI), which uses graphical screen elements, such as windows (which are used to separate the screen into distinct work areas), icons (which are small images that represent computer resources, such as files), pull-down menus (which give a user a list of options), scroll bars (which allow a user to move up and down a window) and buttons (which can be “pushed” with a click of a mouse). A wide variety of applications is known to those in the art.

The phrases “Application Program Interface” and API as are used herein mean a set of commands, functions and/or protocols that computer programmers can use when building software for a specific operating system. The API allows programmers to use predefined functions to interact with an operating system, instead of writing them from scratch. Common computer operating systems, including Windows, Unix, and the Mac OS, usually provide an API for programmers. An API is also used by hardware devices that run software programs. The API generally makes a programmer's job easier, and it also benefits the end user since it generally ensures that all programs using the same API will have a similar user interface.

The phrase “central processing unit” as is used herein means a computer hardware component that executes individual commands of a computer software program. It reads program instructions from a main or secondary memory, and then executes the instructions one at a time until the program ends. During execution, the program may display information to an output device such as a monitor.

The term “execute” as is used herein in connection with a computer, console, server system or the like means to run, use, operate or carry out an instruction, code, software, program and/or the like.

In this disclosure, the descriptions of the various embodiments have been presented for purposes of illustration and are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein. Thus, the appended claims should be construed broadly, to include other variants and embodiments, which may be made by those skilled in the art.

What is claimed is:

1. A system for matching a candidate and a financial sponsor, the system comprising:
at at least one user computing device in operable connection with a user network;
an application server in operable communication with the user network, the application server configured to host an application program for matching the candidate to the financial sponsor, the application program comprising:
a user module configured to enable generation of a candidate profile and a financial sponsor profile;
a matching module configured to match the candidate profile to the financial sponsor profile;
a communication module configured to enable communication between the candidate and the financial sponsor;
a candidate database configured to store a plurality of candidate profiles; and
an AI engine in operable communication with the matching module and the candidate database, the AI engine comprising:
an input classification module configured to receive a user input associated with the financial sponsor and to classify the user input into an input mode selected from a plurality of input modes, the plurality of input modes comprising a document-only mode, a natural-language-only mode, and a document-plus-natural-language mode;
a document type classification module configured to, based on the user input comprising a document input, classify the document input into a document type selected from a plurality of predefined document types, and generate a document type confidence score associated with the document type;
a missing information module configured to determine, based on the document type, a set of missing information fields from a predefined mapping of the plurality of predefined document types to required information fields;
a clarification question module configured to generate a ranked set of clarification questions based on the set of missing information fields, the ranked set of clarification questions limited to a predefined maximum number and ordered based on an expected impact on a ranking of the plurality of candidate profiles;
a retrieval module configured to retrieve, from the candidate database, a subset of candidate profiles from the plurality of candidate profiles based on the user input;
a ranking module configured to rank the subset of candidate profiles against the user input based on a multi-dimensional rubric comprising a seniority dimension, a recency dimension, a tenure length dimension, an ownership context dimension, an operational scale dimension, and a relevant engagement count dimension, subject to one or more override conditions specified in the user input, to generate a ranked subset of candidate profiles; and
an output module configured to generate a structured output comprising the ranked subset of candidate profiles, a retrieval plan identifying a retrieval strategy used by the retrieval module, and an audit trail identifying the input mode, the document type, the set of missing information fields, and a ranking rationale; and
wherein the AI engine is configured to prevent generation of the structured output based on the document type confidence score being below a predefined confidence threshold until at least one clarification question of the ranked set of clarification questions is answered.

2. The system of claim 1, further comprising a verification module configured to verify an identity of the candidate and to verify one or more credentials of the candidate, wherein the AI engine is configured to prevent generation of the structured output based on the verification module not confirming the identity of the candidate.

3. The system of claim 1, further comprising a recommendation module in operable communication with the AI engine, the recommendation module configured to receive the structured output from the AI engine and to recommend the candidate to the financial sponsor based on the ranked candidate profile.

4. The system of claim 1, further comprising a user interface module in operable communication with a display module, the user interface module configured to enable a user to input a plurality of user information comprising at least one of a location, a work history, one or more credentials, an education history, one or more preferences, a title, a plurality of contact information, and a social media account link.

5. The system of claim 1, wherein the plurality of predefined document types comprises a deal teaser type, an investment theme type, a job description type, a resume type, a company description type, and an other type.

6. The system of claim 5, wherein based on the document type being the deal teaser type, the ranked set of clarification questions comprises at least one question regarding a purpose of engagement, the purpose of engagement selected from a deal evaluation purpose, a sector perspective purpose, a board role placement purpose, a chief executive placement purpose, and an operating role placement purpose.

7. The system of claim 5, wherein based on the document type being the job description type, the ranked set of clarification questions comprises at least one question regarding a prior role requirement, a private-equity-backed experience requirement, a target scale range, and a sector strictness level.

8. The system of claim 5, wherein based on the document type being the resume type, the ranked set of clarification questions comprises at least one question regarding a near-clone candidate preference, a broader analog candidate preference, and a role-ready candidate preference.

9. The system of claim 1, wherein the one or more override conditions comprise a title-specificity override configured to, based on the user input specifying a title level, weight a title match above the seniority dimension.

10. The system of claim 1, wherein the one or more override conditions comprise a sector-expertise override configured to, based on the user input specifying a sector strictness level above a sector strictness threshold, weight a sector match above the ownership context dimension.

11. The system of claim 1, wherein the retrieval plan identifies the retrieval strategy as a deterministic retrieval strategy based on the user input specifying a structured constraint, and identifies the retrieval strategy as a full-text expansion retrieval strategy based on the user input lacking the structured constraint.

12. The system of claim 1, wherein the audit trail further identifies an intent hypothesis, a confidence level associated with the intent hypothesis, and a key uncertainty associated with the intent hypothesis.

13. A computer-implemented method for matching a candidate and a financial sponsor, the
method comprising:
receiving, by a processor of an application server, a user input associated with the financial sponsor from a user computing device in operable connection with a user network, the user input comprising at least one of a document input and a natural language input;
classifying, by the processor, the user input into an input mode selected from a plurality of input modes, the plurality of input modes comprising a document-only mode, a natural-language-only mode, and a document-plus-natural-language mode;
based on the user input comprising the document input, classifying, by the processor, the document input into a document type selected from a plurality of predefined document types, and generating a document type confidence score associated with the document type;
determining, by the processor and based on the document type, a set of missing information fields from a predefined mapping of the plurality of predefined document types to required information fields;
generating, by the processor, a ranked set of clarification questions based on the set of missing information fields, the ranked set of clarification questions limited to a predefined maximum number and ordered based on an expected impact on a ranking of a plurality of candidate profiles;
retrieving, by the processor, a subset of candidate profiles from a candidate database storing the plurality of candidate profiles based on the user input;
ranking, by the processor, the subset of candidate profiles against the user input based on a multi-dimensional rubric comprising a seniority dimension, a recency dimension, a tenure length dimension, an ownership context dimension, an operational scale dimension, and a relevant engagement count dimension, subject to one or more override conditions specified in the user input, to generate a ranked subset of candidate profiles;
generating, by the processor, a structured output comprising the ranked subset of candidate profiles, a retrieval plan identifying a retrieval strategy used in the retrieving step, and an audit trail identifying the input mode, the document type, the set of missing information fields, and a ranking rationale;
preventing, by the processor, generation of the structured output based on the document type confidence score being below a predefined confidence threshold until at least one clarification question of the ranked set of clarification questions is answered; and
transmitting, by the processor and via a communication module, the structured output to the user computing device.

14. The computer-implemented method of claim 13, further comprising:
generating, by the processor, an intent hypothesis associated with the user input, the intent hypothesis selected from a plurality of intent types comprising a deal assessment intent, an investment theme intent, a hiring intent, a board intent, and an advisory intent;
selecting, by the processor, the hiring intent as the intent hypothesis based on the user input specifying a role title; and
selecting, by the processor, the deal assessment intent as the intent hypothesis based on the user input not specifying the role title.

15. The computer-implemented method of claim 13, wherein classifying the document input into the document type further comprises extracting, by the processor and from the document input, one or more evidence phrases supporting the classification of the document input into the document type, and wherein the audit trail further identifies the one or more evidence phrases.

16. The computer-implemented method of claim 13, further comprising, based on the document type confidence score being at or above the predefined confidence threshold, generating, by the processor, the structured output without the at least one clarification question being answered, wherein the audit trail further identifies one or more assumptions applied by the processor in generating the structured output.

17. The computer-implemented method of claim 13, wherein generating the structured output comprises formatting the structured output as a structured data object comprising a plurality of named fields, the plurality of named fields comprising an intent field identifying an intent hypothesis associated with the user input and a confidence associated with the intent hypothesis, a classification field identifying the input mode and the document type, a missing information field identifying the set of missing information fields, and a clarifying questions field identifying the ranked set of clarification questions.

18. A non-transitory computer-readable medium storing computer-executable instructions for
matching a candidate and a financial sponsor, the computer-executable instructions, when executed by a processor of an application server, causing the processor to perform operations comprising:
receiving a user input associated with the financial sponsor from a user computing device in operable connection with a user network, the user input comprising at least one of a document input and a natural language input;
classifying the user input into an input mode selected from a plurality of input modes, the plurality of input modes comprising a document-only mode, a natural-language-only mode, and a document-plus-natural-language mode;
based on the user input comprising the document input, classifying the document input into a document type selected from a plurality of predefined document types, and generating a document type confidence score associated with the document type;
determining, based on the document type, a set of missing information fields from a predefined mapping of the plurality of predefined document types to required information fields;
generating a ranked set of clarification questions based on the set of missing information fields, the ranked set of clarification questions limited to a predefined maximum number and ordered based on an expected impact on a ranking of a plurality of candidate profiles;
retrieving a subset of candidate profiles from a candidate database storing the plurality of candidate profiles based on the user input;
ranking the subset of candidate profiles against the user input based on a multi-dimensional rubric comprising a seniority dimension, a recency dimension, a tenure length dimension, an ownership context dimension, an operational scale dimension, and a relevant engagement count dimension, subject to one or more override conditions specified in the user input, to generate a ranked subset of candidate profiles;
generating a structured output comprising the ranked subset of candidate profiles, a retrieval plan identifying a retrieval strategy used in the retrieving operation, and an audit trail identifying the input mode, the document type, the set of missing information fields, and a ranking rationale;
preventing generation of the structured output based on the document type confidence score being below a predefined confidence threshold until at least one clarification question of the ranked set of clarification questions is answered; and
transmitting, via a communication module, the structured output to the user computing device.

19. The non-transitory computer-readable medium of claim 18, wherein the one or more override conditions comprise a scale-fit override, and wherein the operations further comprise, based on the user input specifying a target scale range, filtering the subset of candidate profiles to exclude a candidate profile associated with an operational scale outside the target scale range.

20. The non-transitory computer-readable medium of claim 18, wherein the seniority dimension comprises a ranked hierarchy in which a chief executive officer role is ranked above a board role, the board role is ranked above a chief operating officer role, and the chief operating officer role is ranked above a chief financial officer role.
